(19) United States
(12) Patent Application Publication
(10) Pub. No.: US 2014/0199439 A1
(43) Pub. Date: Jul. 17, 2014

(54) COATED CALCIUM PARTICULATES FOR USE IN BEVERAGE PRODUCTS

(71) Applicant: SUNNY DELIGHT BEVERAGES COMPANY, Cincinnati, OH (US)

(72) Inventors: Robert J. SARAMA, Loveland, OH (US); Gregory Arcuino, Cincinnati, OH (US)

(73) Assignee: SUNNY DELIGHT BEVERAGES COMPANY, Cincinnati, OH (US)

(21) Appl. No.: 14/151,425

(22) Filed: Jan. 9, 2014

Related U.S. Application Data
(60) Provisional application No. 61/752,084, filed on Jan. 14, 2013.

(51) Int. Cl. A23L 1/304; A23L 2/52

(52) U.S. Cl. CPC A23L 1/304; A23L 2/52
USPC 426/72

(57) ABSTRACT

Coated particulate material used to enable the incorporation of calcium materials in a beverage product (especially those having a low pH) preserved with sodium hexametaphosphate (SHMP) are disclosed. The particulates are made up of a substrate material, such as a calcium salt, such as calcium phosphate. The substrate material can, in preferred embodiments, be incorporated into a prill which utilizes a sterol as the prilling material. The substrate material, preferably in the form of a prill, is then coated with a phospholipid coating, such as hydrogenated phosphatidyl choline, such that the final coated particulate product includes from about 70% to about 200% (by weight of the substrate) of the phospholipid coating. Beverage compositions which include these coated particulates are also disclosed.

The present application is related to and claims priority from U.S. Provisional Patent Application No. 61/752,084, filed Jan. 14, 2013, incorporated by reference herein.

### BACKGROUND OF THE INVENTION

Beverage products frequently utilize sodium hexametaphosphate (SHMP) as a preservative. The SHMP functions by chelating and thus preventing calcium, iron and magnesium utilization by micro-organisms; this interrupts their physiology resulting in the organisms' death. While it is desirable to provide calcium fortification in some beverage products, the presence of calcium generally is incompatible with SHMP.

Prior work suggests that the form of the calcium salt combined with SHMP dictates how much calcium will actually be chelated. For example, when calcium chloride and calcium hydroxide are added to individual SHMP solutions, the level of free (non-chelated) calcium ion measured in solution is 82% and 0.05%, respectively (ions measured using the Ion Selective Electrode (ISE) testing).

These data suggest that it might be possible to maintain a high level of calcium ion in solution, while in combination with SHMP, if calcium chloride is used. Micro challenge testing of this approach, however, showed that the organisms actually grew at an accelerated rate, therefore negating its value. In addition, using a calcium salt having limited or no solubility, such as calcium carbonate, at neutral pH, tends to release its metallic cations in the beverage, which deactivates the SHMP. Further, if a calcium-based compound like calcium carbonate with a specific gravity of 2.7 is added to the beverage, at neutral pH, particles of the compound will quickly settle to the bottom of that product. Because the particles are hard and irregularly shaped, they deliver a gritty and undesirable sensation to the consumer upon swallowing.

Thus, providing an aesthetically formulated calcium-supplemented beverage product, which uses SHMP as a preservative, is a challenge.

### SUMMARY

The present invention provides a way to deliver calcium from a low pH SHMP-containing beverage:
(1) without deactivating the preservative system;
(2) without causing a palatability problem; and
(3) without causing major settling of the delivered calcium.

Since the test results suggest that one cannot deliver calcium ions in solution and, at the same time, have SHMP function as a preservative, even if the calcium does not become chelated by the SHMP, the approach taken was to focus on delivering calcium in a different form. We know that insoluble calcium (e.g., calcium carbonate or calcium phosphate) reacts with SHMP at low pH, and that delivering hard particles in a beverage causes palatability and swallowing issues.

The present invention therefore defines a coated particle, having a particle size of from about 4 μm to about 10 μm, comprising a substrate consisting essentially of a material selected from calcium salts, iron salts and alkali earth metal salts (preferably calcium salts), oxidative labile vitamins, and combinations thereof, and from about 70% to about 200% (by weight of the substrate) of a phospholipid coating. In a preferred embodiment, the substrate is in the form of a prill consisting essentially of a sterol and the substrate material selected from calcium salts, iron salts and alkali earth metal salts, oxidative labile vitamins, and combinations thereof. Preferably, the substrate material is a calcium salt, such as calcium phosphate.

The present invention also encompasses beverage compositions (preferably those preserved using SHMP) which comprise from about 0.3% to about 3% of the coated particulate material, defined above. The beverage compositions typically have a low pH, for example, a fruit juice or citrus fruit-derived beverage, having a pH of from about 2.9 to about 3.6.

All percentages and ratios given herein are “by weight” unless otherwise specified. All patents, patent applications and publications noted herein are incorporated herein by reference.

### DETAILED DESCRIPTION

The present invention utilizes a substrate material in the form of particles having an average diameter of from about 1 to about 2 microns (vim) selected from calcium salts, iron salts, alkali earth metal salts, oxidative labile vitamins, and combinations of those materials. Calcium salts are preferred materials. Examples of such calcium salts include calcium phosphate, calcium carbonate, calcium chloride, calcium sulfate, calcium hydroxide, calcium hydroxyapatite, calcium salts of long chain polyphosphates, calcium salts of carboxylates (which may include calcium citrate, calcium malate, calcium citrate malate, calcium lactate, and calcium salts of amino acids and fatty acids), calcium ascorbate, calcium glycerylphosphate, calcium polycarbophil, calcium fructoborate, calcium glucoheptonate, and combinations of those materials. A particularly preferred material is calcium phosphate. When selecting the calcium salts for use in the present invention, preference is given to calcium salts which include a high calcium loading (i.e., a major proportion of the calcium salt is made up of the calcium component) since such materials allow the use of a lower level of particulate material in order to achieve the desired calcium level for the finished product.

In a preferred embodiment, the substrate material is included in a prill. A prill is a small aggregate of a material, most often a dry sphere, formed from a melted liquid. The material to be prilled is generally solid at room temperature and a low viscosity liquid when melted. Prills are often formed by allowing drops of the melted prill substance to congeal or freeze in mid-air after being dripped from the top of a tall prilling tower. Melted material may also be atomized and then allowed to form smaller prills that are useful in cosmetics, food, and animal feed. Prills have also been used to protect active ingredients from exposure to environmental factors and to cover up the flavor of bitter materials for oral consumption. Prilling is a well-known technique and is disclosed, for example, in U.S. Pat. No. 3,071,804, Meek, issued Jan. 8, 1963, incorporated herein by reference.

The prill of the substrate material, when used herein, is formed in order to prevent release of the substrate material, and particularly calcium, under the acidic conditions frequently found in a juice beverage product. If the calcium would be released into such a beverage product, it would react and deactivate the SHMP included in the product.

The material utilized for formation of the prills herein is a sterol because such materials are not water-soluble, but are digestible in the body. This sterol should be a non-polar sterol which is soluble in the prilling solvent (such as hexane). It should have a melting point of from about 135 C. to about 158 C. The sterol should be selected so as to provide a prill which has some deformability, but is not too hard and, therefore, does not form prills having sharp points. This allows for better coating by the phospholipid described later in this application. The prilling technique utilized in the present invention can be a solvent-based prill. After the prill is formed, it is cooled so as to encapsulate the calcium material into the prill, although non-solvent-based or “neat” prilling can also be used. A particularly preferred prill forming material is Corowise® phytosterol, commercially available from Cargill Inc. The prilling material includes beta-sitosterol, campesterol, and/or stigmasterol; brassicasterol, sitosterol and/or campestanol can also be included. These components can be either used alone or in admixture. The Cargill product includes a mixture of beta-sitosterol, campesterol and stigmasterol having a weight ratio of beta-sitosterol:campesterol:stigmasterol, of about 2:1:1. The ratio of the components can be adjusted in order to control the deformability of the final prills.

Additional non-limiting examples of the prilling material include the following:

| | B-sitosterol | Campesterol | Stigmasterol | Brassicasterol | Sitostanol | Campestanol |
|---|---|---|---|---|---|---|
| | MP | MP | MP | MP | MP | MP |
| Product | 136-140 C. | 157-158 C. | 161-170 C. | 150-151 C. | 127-132 C. | 145-146 C. |
| B-Sitosterol, | 57 | 23 | 11 | 9 | n/a | n/a |
| soybean, ≧40% | | | | | | |
| Phytopin | 76.3 | 7.5 | n/a | n/a | 10.4 | 1.1 |
| Corowise | 41.9 | 25.2 | 19.4 | n/a | n/a | n/a |
| FP-xxx | | | | | | |
| series | | | | | | |
| Corowise | 77 | 6.7 | 0.6 | n/a | n/a | n/a |
| FP-xxxE | | | | | | |
| series | | | | | | |
| Vegapure | 42.1 | 27.1 | 17.9 | 5.9 | 1.6 | 0.3 |
| FS | | | | | | |
| Vegapure | 78 | 6.7 | 0.8 | 0 | 10 | 1 |
| 867G | | | | | | |

Suitable sterols include, but are not limited to, those rich in B-sitosterol, campesterol and stigmasterol, such as Vegapure 86 (commercially available from Cognis Corporation).

The prill used herein typically contains from about 50% to about 95%, preferably from about 50% to about 70% sterol and from about 5% to about 50%, preferably from about 3% to about 50%, of the substrate material.

The prill (or the substrate material, if no prill is utilized) is then coated with a phospholipid in order to form the particulate coated product of the present invention. The phospholipid material is preferably hydrogenated since that forms particulate materials which are not sticky and remain separate (i.e., they do not clump), thereby allowing for easy use and handling. The prill is coated with a mixture of hydrogenated phospholipid and ethanol (or other solvent). Ethanol is a preferred solvent because the prill material is not soluble in it, but the phospholipid is soluble in it, thereby allowing for an easy coating operation. Other solvents can be used as long as they meet these criteria. A preferred phospholipid material is Phospholipon® 80H, commercially available from Phospholipid GmbH, Cologne, Germany. A particularly preferred phospholipid material is a hydrogenated phosphatidyl choline. Other phospholipid materials can be utilized, but they should be hydrogenated.

The coated particles contain from about 60% to about 200%, preferably from about 70% to about 200%, or from about 70% to about 150% (by weight of the prilled substrate), of the phospholipid coating. The coated particles range in size from about 4 μm to about 10 μm. The coating can be a mixture of phospholipids, preferably hydrogenated phospholipids, such that the coating material has a compositional melting point between about 150 and about 170 Celsius, and maintains the ability to quickly crystallize, and provide a coating which is friable, malleable and cohesive to the substrate. Phospholipids are important to be utilized as the coating since, in the beverage context (i.e., in the presence of water), the phospholipid hydrates to form a lubricious boundary layer around the particle, which facilitates swallowing of the beverage.

The coating agent is delivered to the substrate by dissolving it in a solvent. Characteristics of the solvent system have been previously described. The solution is then applied by conventional means, for example, through a fluidized bed spray coater or a pan coater. The solvent and solvent to coating ratio is selected to: (1) completely dissolve the coating composition, (2) to deliver a uniform coating matrix on the particle, and (3) to prevent premature flashing or drying of the solvent to prevent premature crystallization of the coating. While several suitable coatings can be used, they should be suitable for food applications and not be chlorinated. Ideally, the solvent or solvent system would have a Haldebrand Solubility Index of from about 7.5 to about 9.0 and a Snyder Polarity Index of from about 0.6 to about 2.4. Solvents well-suited for this application include hexane and ethanol, although other alkanes, alcohols or esters, meeting the properties discussed above, can be utilized.

Preparation of the coating for application involves the dissolution of the coating composition in the solvent or solvent system at ambient temperatures not to exceed about 70° C.

The coating can be applied to the substrate, for example, by fluidized bed spray coating or spray drying. The coating is dissolved in a food approved solvent and sprayed onto the substrate particles. As the solvent quickly evaporates, the coating forms on the substrate particles. In a second approach, the prill is added to an ethanol/phospholipid mixture and co-spray dried. Starting calcium particles are initially from about 1 to about 2 μm in diameter and the coated particles are from about 4 to about 10 μm in diameter. The coating typically comprises from about 60% to about 99%, preferably from about 70% to about 98% (by weight), of the final particulate product with the substrate (the salt and/or the prill) being the remainder of the composition. Because the density of the final particles is between about 0.9 and about 1.5 g/mL (the density of the coating can be, for example, about 0.94 g/mL), the coating balances out the higher specific gravity density of the calcium material in the substrate (specific gravity is about 2.7 for calcium carbonate) thereby making the particle easy to suspend in a beverage. Further, the coated particles are able to withstand pasteurization temperatures and can easily be swallowed in the beverage. An added benefit is that the particles can be used to deliver cloud (opacity) to the beverage (replacing or supplementing emulsions) and provide a convenient way to add vitamin D to the beverage. Since the particles deliver opacity to the beverage and remain suspended in the beverage while requiring little or no suspending agent, the product can be made at reduced cost.

An example of a substance for use in the present invention is calcium phosphate. The particles described herein shield the calcium from reacting with the SHMP present in the beverage product as a preservative. Per FDA requirements, a minimum of 10% RDI calcium needs to be delivered to fortify the product with Vitamin D (present in a nutritionally effective amount). The coating is applicable to any small labile particle that needs to be delivered in a beverage or food product. The beverage products which utilize the particles of the present invention include the particle at from about 0.3% to about 3% (by weight) of the beverage composition. The beverages are frequently acidic and may have, for example, a pH between about 2.5 and about 4.5, such as from about 2.9 and about 3.6.

### Example

A non-limiting example of the coated particles of the present invention, the method of making those coated particles, and a beverage product which incorporates the particles of the present invention, follows:

### Prill Formation

Tricalcium phosphate (Sigma-Aldrich)—Lot #BCBK3615V is sourced and milled in a 9 L Food Jar Mill (⅜ inch cylindrical zirconia media) for 24 hours in order to reduce particle size from 7 microns down to less than 3 microns.

Phytosterols (Cargill)—Lot #PS-LK-080913 is sourced and placed in an oven at 150 C. overnight to begin the melting process.

Nine hundred (900) grams of semi-molten phytosterols are placed in a heated-stainless steel container and High Shear Mixed using a Silverson Mixer.

Once the phytosterols are melted, 600 grams of the milled tricalcium phosphate are added. High Shear mixing is continued for approximately 10 minutes in order to keep the mixture homogeneous.

The mixture is then introduced into a Niro Mobile Minor Dryer equipped with 2 fluid nozzles for prilling. Flow rate and prill chilling are adjusted in order to produce prills of 10 microns or less.

Yield of this run rquals 982 grams (65.5%) of the prills.

Mean particle size is measured using a Moriba Scattering PSD Analyzer LA-950.

Further analyses include Thermo-gravimetric Analysis (TGA)—TA Instruments Q-500, and, FEI Phenom SEM Microscope.

### Frill Coating

Five hundred grams (500 g.) of Phospholipon® 80H (Hydrogenated Phosphalidycholine) are added to 3,500 grams of 200 proof ethanol and heated to 65 C.

Once the Phospholipid is melted, 250 grams of the calcium prill produced in the first step are added and mixed.

The mixture is continuously mixed to prevent settling while being fed into the Niro Mobile Minor Dryer now set-up for spray drying. Conditions are adjusted to ensure flashing of the ethanol and crystallization of the phospholipid.

This run yields approximately 540 grams of the coated prills.

The coated prill is then placed in an acidic water solution, buffered to pH 3.0, and tested for calcium leaching using a Mettler ISE electrode and T-70 Titrator.

Results show excellent results with equal to or less than 1 ppm of calcium loss.

About 1% of the coated prill particulate is added to a sweetened citrus-based beverage product having a pH of about 3.0. The particulate provides calcium supplementation to the beverage without interfering with the effectiveness of the SHMP preservative used in the beverage. The particulates cannot be perceived in the mouth when the beverage is consumed.

What is claimed is:

1. A coated particulate, having a particle size of from about 4 μm to about 10 μm, comprising a substrate consisting essentially of a material selected from calcium salts, iron salts, and alkali earth metal salts, oxidative labile vitamins, and combinations thereof; and from about 70% to about 200% (by weight of the substrate) of a phospholipid coating.

2. The particulate according to claim 1 wherein the substrate is in the form of a prill consisting essentially of a sterol and the substrate material selected from calcium salts, iron salts and alkali earth metal salts, oxidative labile vitamins and combination thereof.

3. The particulate according to claim 2 wherein the sterol material is hydrogenated.

4. The particulate according to claim 3 wherein the prill consists essentially of from about 50% to about 70% sterol and from about 30% to about 50% of the substrate material.

5. The particulate according to claim 4 wherein the substrate material is a calcium salt.

6. The particulate according to claim 5 wherein the sterol is non-polar and is soluble in the prilling solvent.

7. The particulate according to claim 6 wherein the calcium salt is selected from calcium phosphate, calcium chloride, calcium carbonate, calcium sulfate, calcium hydroxide, calcium hydroxyapatite, calcium salts of long chain polyphosphates, calcium salts of carboxylates, calcium ascorbate, calcium glycerylphosphate, calcium polycarbophil, calcium fructoborate, calcium glucoheptonate, and mixtures thereof.

8. The particulate according to claim 7 wherein the calcium salt is calcium phosphate.

9. The particulate according to claim 8 wherein the sterol material is selected from (a) beta sitosterol, (b) campesterol, (c) stigmasterol, and mixtures thereof.

10. The particulate according to claim 9 wherein the sterol is a mixture of (a), (b) and (c), having a weight ratio (a):(b):(c) of about 2:1:1.

11. The particulate according to claim 7 wherein the phospholipid is a hydrogenated phospholipid material.

12. The particulate according to claim 11 wherein the phospholipid is a hydrogenated phosphatidyl choline.

13. The particulate according to claim 10 wherein the phospholipid material is a hydrogenated phosphatidyl choline.

14. The particulate according to claim 12 which additionally comprises a nutritionally effective amount of vitamin D.

15. The particulate according to claim 12 having a density of from about 0.9 to about 1.5 g/mL.

16. A beverage composition, having a pH of from about 2.9 to about 3.6, comprising from about 0.3 to about 3% of the particulate material according to claim 2.

17. A beverage composition, having a pH of from about 2.9 to about 3.6, comprising from about 0.3 to about 3% of a particulate material according to claim 7.

18. A beverage composition, having a pH of from about 2.9 to about 3.6, comprising from about 0.3 to about 3% of a particulate material according to claim 10.

19. A beverage composition, having a pH of from about 2.9 to about 3.6, comprising from about 0.3 to about 3% of a particulate material according to claim 12.

20. A beverage composition according to claim 16 which additionally comprises an effective amount of sodium hexametaphosphate as a preservative.

21. A beverage composition according to claim 18 which additionally comprises an effective amount of sodium hexametaphosphate as a preservative.
